(19) United States
(12) Patent Application Publication
(10) Pub. No.: US 2008/0104066 A1
(43) Pub. Date: May 1, 2008

(54) VALIDATING SEGMENTATION CRITERIA

(75) Inventor: Jian Wang, San Jose, CA (US)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/553,585

(22) Filed: Oct. 27, 2006

(51) Int. Cl. G06F 17/30

(52) U.S. Cl. 707/6

(57) ABSTRACT

Segmentation criteria are validated relative to a plurality of items organized according to a dimensionally-modeled data space. Each criterion nominally characterizes a segment comprising an area of interest of the dimensionally-modeled data space. The items are mapped to the segments. The mapping is processed. Based on the mapping, the validity of the segmentation criteria is evaluated, and a result of the evaluation is reported.

### BACKGROUND

Data analysis can be significant to many industries. In a basic sense, an analyst defines segmentation criteria to an item collection and, based on the outcome, a business action may be made with respect to all items in particular segments characterized by the segmentation criteria, rather than with respect to individual items without regard for any segmentation of the items. The item collection typically holds item records organized according to a dimensionally-modeled data space. The criteria nominally characterize regions of interest of the dimensionally-modeled data space defined by a plurality of dimensions. Each dimension corresponds to a particular attribute.

For example, the items may be users of online services such as services provided by Yahoo! Inc., of Sunnyvale, Calif., and the item records may include characteristics (e.g., self-reported and/or behavioral) with respect to the users. A user selection query may be attempted to determine the users in various segments, where a different business action may be performed with respect to the users in each segment. For example, a system may be configured such that users determined to be in a particular segment are subject to being targeted with a particular advertisement.

### SUMMARY

Segmentation criteria are validated relative to a plurality of items organized according to a dimensionally-modeled data space. Each criterion nominally characterizes a segment comprising an area of interest of the dimensionally-modeled data space. The items are mapped/classified to the segmentation criteria. The mapping is processed. Based on the mapping, the validity of the segmentation criteria is evaluated, and a result of the evaluation is reported.

### BRIEF DESCRIPTION OF THE DRAWINGS

FIG. 1 illustrates a simple example of segmentation of a one-dimension dimensionally-modeled data space.

FIG. 2 illustrates another simple example of segmentation of a two-dimension dimensionally-modeled data space.

FIG. 3 illustrates, using a simple one-dimension example similar to the FIG. 1 example, an example in which there is a gap between the C1 segment and the C2 segment.

FIG. 4 illustrates, using a simple one-dimension example similar to the FIG. 1 example, an example in which there is overlap between the D2 segment and the D3 segment.

FIG. 5 illustrates an example in which six segments S1 to S6 are each defined in view of a combination of value ranges, for up to eight attributes a1 to a8.

FIG. 6 is a flowchart broadly illustrating steps to validate segmentation criteria relative to item records organized according to a dimensionally-modeled data space

### DETAILED DESCRIPTION

Particularly as the number of dimensions of a data space increases, it can be difficult for an analyst to define proper segmentation criteria that, for example, are sufficient to put the items, whose fact value attributes are held in the data collection, into segments in a well-defined manner. That is, it may unintentionally occur that some items occur in no defined segment or in multiple segments.

In accordance with an aspect, a method is described herein to validate segmentation criteria to an item collection that includes item records existing within a dimensionally-modeled data space. Broadly speaking, key attributes of the population of items are used for segmenting purposes. For example, a segment may be defined by a value range for one or more key attributes. Based on the segment definitions, the whole population is segmented such that each item of the population is mapped to appropriate segments based on the defined value ranges for one or more key attributes, for those segments. Based on the containment of each item in the segments, it is determined whether the segmentation criteria are sufficient to put the items into the segments in a well-defined manner.

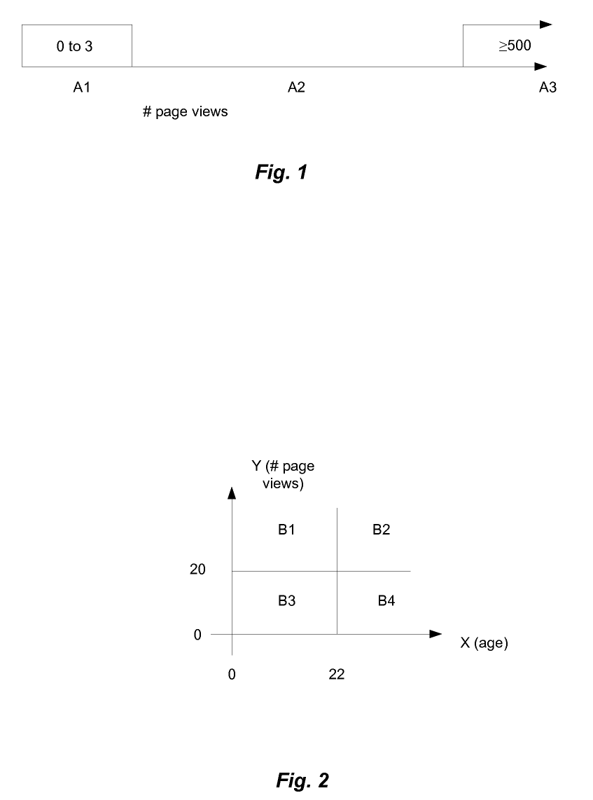

FIG. 1 illustrates a simple example of segmentation criteria for a dimensionally-modeled data space. Segments A1, A2 and A3 are defined to exist in a one-dimensional data space. The one dimension is “# page views.” This may indicate, for example, the number of web pages viewed by a particular user during some time period. The segment A1 criterion corresponds to items having a # page views attribute value of 0 to 3. The segment A2 criterion corresponds to items having a # page views attribute value of greater than 3 and less than 500. Finally, the segment A3 criterion corresponds to items having a # page views attribute value of 500 or greater. Given the simplicity of the correspondence between the segmentation criteria and the attribute boundaries in the one dimension, it can be easily seen by inspection that no segment overlaps another segment, nor are there any gaps between segments.

FIG. 2 illustrates another simple example of segmentation criteria for a dimensionally-modeled data space. Segments B1 to B4 are defined to exist in a two-dimensional data space (one dimension for the age attribute and one dimension for the # page views attribute). Similar to the FIG. 1 example, it can be relatively easily seen by inspection that no segment overlaps another segment, nor are there any gaps between segments.

However, for other dimensionally-modeled data spaces (e.g., dimensionally-modeled data spaces in which segmentation is defined in more than two dimensions, particularly in which segmentation is defined in many more than two dimensions), it may be difficult or impossible to see by inspection whether there is overlap or there are gaps.

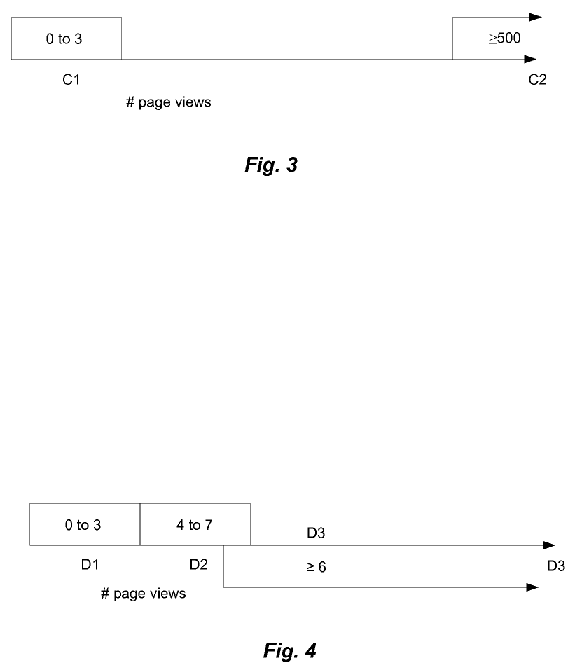

FIG. 3 illustrates, using a simple one-dimensional example similar to the FIG. 1 example, an example in which there is a gap between the defined C1 segment corresponding to items having a # page views attribute value of 0 to 3 and the defined C2 segment corresponding to items having a # page views attribute value of 500 or greater. FIG. 4 illustrates, using a simple one-dimensional example similar to the FIG. 1 example, an example in which there is overlap between the defined D2 segment corresponding to items having a # page views attribute value of 4 to 7 and the defined D3 segment corresponding to items having a # page views attribute value of 6 and higher. In both the FIG. 3 example and the FIG. 4 example, it is a relatively simple matter to see the overlap and gap relative to the segment definitions.

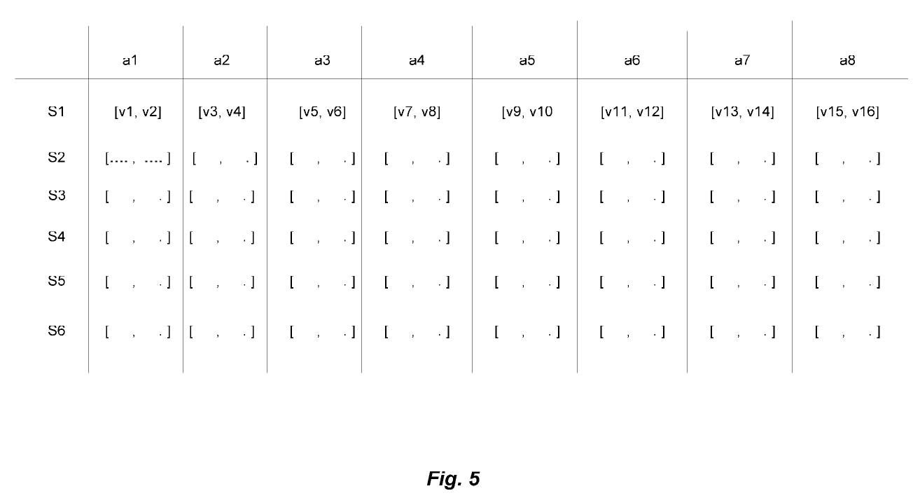

By contrast, FIG. 5 illustrates an example in which six segments S1 to S6 are each defined in view of a combination of value ranges, for up to eight attributes a1 to a8. The row in FIG. 5 for defined segment S1 indicates the value ranges for attributes a1 to a8 as [v1, v2], [v3, v4], [v5, v6], etc., respectively. (The rows in FIG. 5 for the other defined segments S2 to S6 do not explicitly show the value ranges for the attributes, instead showing “[ . . . , . . . ]” for each attribute range.) It can be seen that, given the large number of possible combinations of value ranges for the defined segments, it may be difficult or impossible to see by inspection whether there are defined segments overlapping or there are gaps between defined segments.

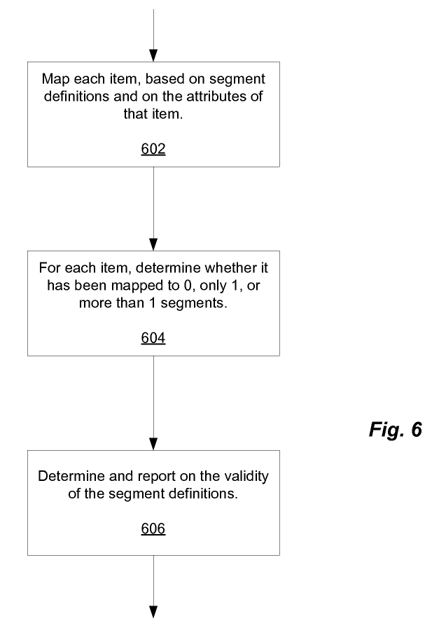

FIG. 6 is a flowchart broadly illustrating steps to validate segmentation criteria relative to item records organized according to a dimensionally-modeled data space. Locations in an n-dimensional data space are specified by n-tuples of attribute values, where each member of the tuple corresponds to one of the n dimensions. Similarly, referring, for example, to FIG. 5, segmentation criteria are specified by n-tuples of value ranges. Each member of the tuple corresponds to one of the n dimensions.

Referring again to FIG. 6, step 602 comprises mapping each item of the data collection to the segments, by matching the attribute values of the items with the value ranges specified by the segmentation criteria.

In general, the segmentation criteria is according to “n” key attributes, where “n” is less than “m,” which is the number of dimensions of the dimensionally-modeled data space. The items mapped in step 602 may be active items, for which records exist in the data collection. On the other hand, the items may be “pseudo-items” (i.e., not necessarily having a corresponding record in the data collection) each characterized by a different combination of values of the segmentation attributes. At step 604, it is determined whether the items item (whether a real item or a pseudo-item) may map to zero, one or more than one segmentation criterion. In one example, if each item maps to one and only one segmentation criterion, then the segmentation criteria are validated as, collectively, having no gaps or overlap. Otherwise, if an item maps to no segmentation criterion, then this indicates that there are gaps in the segmentation criteria. If any item maps to more than one segment, then this indicates that there is overlap in the segmentation criteria.

At step 606, the validity of the segmentation definitions is determined, based on the determination of whether the items map to no segment, to one segment or to multiple segments.

In one example, to map the items of a whole population into segments, the following steps can be taken: 1) For each of the segments, based on only its criterion, create all its items (active and pseudo), to determine what segment contains what items. 2) For each item of the whole population, check the segments to find all the segments that contain this active item (by comparing each attribute/dimension of this active item with those of an item contained in a segment). The number of segments containing this item can be 0, 1 or multiple. A nested loop of processing may be utilized in both above steps, where, for each segmentation criterion, the attribute variable for one dimension is varied within the range for the segmentation criterion, keeping the other values constant. At each iteration of the loop, it is determined based on the combination of attribute variables for that loop iteration, which (if any) items correspond to the segment characterized by that segmentation criterion. In this example, the nested loop of processing is separately utilized for each segmentation criterion, so that the appropriate item or items can be mapped to the segment characterized by that segmentation criterion.

The FIG. 6 process may be carried out, for example, by a general purpose or other computer. For example, a storage device may hold the segmentation criteria, and a processing unit of the computer may execute the FIG. 6 processing. A report (e.g., indicating “valid or not valid” or more detailed) may be provided, such as being accessible to a user to view on a display, on paper or even held in a file for later access.

We have described an example of a method to validate segmentation criteria to an item collection that includes item records existing within a dimensionally-modeled data space.

1. A method of validating segmentation criteria relative to a plurality of items organized according to a dimensionally-modeled data space, wherein each criterion nominally characterizes a segment comprising an area of interest of the dimensionally-modeled data space, the method comprising:
mapping the items to the segments characterized by the segmentation criteria;
processing the mapping and evaluating, based thereon, validity of the segmentation criteria; and
reporting a result of the evaluating.

2. The method of claim 1, wherein:
processing the mapping includes:
for each of at least some of the items, determining whether that item is not mapped to any of the segments; and
determining the propriety of the segmentation criteria based at least in part on the determinations of whether an item is not mapped to any of the segments.

3. The method of claim 1, wherein:
processing the mapping includes:
for each of at least some of the items, determining whether that item is mapped to more than one of the segments; and
determining the propriety of the segmentation criteria based at least in part on the determinations of whether at least one item is mapped to more than one of the segments.

4. The method of claim 1, wherein:
mapping the items to the segments includes, for every attribute combination of each segmentation criterion, determining whether an item maps to a segment characterized by that attribute combination.

5. The method of claim 4, wherein:
the mapping step includes considering every attribute combination of each segmentation criterion.

6. The method of claim 1, wherein:
the reporting step includes reporting whether there are any gaps among the segments.

7. The method of claim 1, wherein:
the reporting step includes reporting whether there is any overlap among the segments.

8. The method of claim 1, wherein:
the items are actual items for which there are corresponding records.

9. The method of claim 1, wherein:
the items are pseudo-items, each characterized by a different combination of values of key attributes, according to which the segmentation criteria are defined.

10. (canceled)

11. A computer program product for validating segmentation criteria relative to a plurality of items organized according to a dimensionally-modeled data space, wherein each criterion nominally characterizes a segment comprising an area of interest of the dimensionally-modeled data space, the computer program product comprising at least one computer-readable medium having computer program instructions stored therein which are operable to cause the at least one computing device to:
map the items to the segments characterized by the segmentation criteria;
process the mapping and evaluate, based thereon, validity of the segmentation criteria; and
report a result of the evaluating.

12. The computer program product of claim 11, wherein:
the computer program instructions operable to cause the at least one computing device to process the mapping includes computer program instructions operable to cause the at least one computing device to:
for each of at least some of the items, determine whether that item is not mapped to any of the segments; and
determine the propriety of the segmentation criteria based at least in part on the determinations of whether an item is not mapped to any of the segments.

13. The computer program product of claim 11, wherein:
the computer program instructions operable to cause the at least one computing device to process the mapping includes computer program instructions operable to cause the at least one computing device to:
for each of at least some of the items, determine whether that item is mapped to more than one of the segments; and
determine the propriety of the segmentation criteria based at least in part on the determinations of whether at least one item is mapped to more than one of the segments.

14. The computer program product of claim 11, wherein:
the computer program instructions operable to cause the at least one computing device to map the items to the segments includes computer program instructions operable to cause the at least one computing device to:
for every attribute combination of each segmentation criterion, determine whether an item maps to a segment characterized by that attribute combination.

15. The computer program product of claim 14, wherein:
the computer program instructions operable to cause the at least one computing device to map the items to the segments includes computer program instructions operable to cause the at least one computing device to:
consider every attribute combination of each segmentation criterion.

16. The computer program product of claim 11, wherein:
the computer program instructions operable to cause the at least one computing device to report a result of the evaluating includes computer program instructions operable to cause the at least one computing device to:
report whether there are any gaps among the segments.

17. The computer program product of claim 11, wherein:
the computer program instructions operable to cause the at least one computing device to report a result of the evaluating includes computer program instructions operable to cause the at least one computing device to:
report whether there is any overlap among the segments.

18. The computer program product of claim 11, wherein:
the items are actual items for which there are corresponding records.

19. (canceled)

20. A computing system, wherein the computing system is configured to validate segmentation criteria relative to a plurality of items organized according to a dimensionally-modeled data space, wherein each criterion nominally characterizes a segment comprising an area of interest of the dimensionally-modeled data space, the computing system configured to:
map the items to the segments characterized by the segmentation criteria;
process the mapping and evaluate, based thereon, validity of the segmentation criteria; and
report a result of the evaluating.

21. The computing system of claim 20, wherein:
the computing system being configured to process the mapping includes the computing system being configured to:
for each of at least some of the items, determine whether that item is not mapped to any of the segments; and
determine the propriety of the segmentation criteria based at least in part on the determinations of whether an item is not mapped to any of the segments.

22. The computing system of claim 20, wherein:
the computing system being configured to process the mapping includes the computing system being configured to:
for each of at least some of the items, determine whether that item is mapped to more than one of the segments; and
determine the propriety of the segmentation criteria based at least in part on the determinations of whether at least one item is mapped to more than one of the segments.

23. The computing system of claim 20, wherein:
the computing system being configured to map the items to the segments includes the computing system being configured to:
for every attribute combination of each segmentation criterion, determine whether an item maps to a segment characterized by that attribute combination.

24. The computing system of claim 23, wherein:
the computing system being configured to map the items to the segments includes the computing system being configured to:
consider every attribute combination of each segmentation criterion.

25. The computing system of claim 20, wherein:
the computing system being configured to report a result of the evaluating includes the computing system being configured to:
report whether there are any gaps among the segments.

26. The computing system of claim 20, wherein:
the computing system being configured to report a result of the evaluating includes the computing system being configured to:
report whether there is any overlap among the segments.

27. (canceled)

28. The computing system of claim 20, wherein:
the items are pseudo-items, each characterized by a different combination of values of key attributes, according to which the segmentation criteria are defined.
